(19) United States
(12) Patent Application Publication
(10) Pub. No.: US 2011/0121655 A1
(43) Pub. Date: May 26, 2011

(54) INVERTER WITH UNINTERRUPTIBLE POWER SUPPLY FOR WATER PUMP

(76) Inventor: Clement LIU, Kuei Jen Hsieng (TW)

(21) Appl. No.: 12/625,546

(22) Filed: Nov. 24, 2009

(51) Int. Cl. H02J 3/00

(52) U.S. Cl. 307/77

(57) ABSTRACT

An inverter with uninterruptible power supply for a water pump includes a plurality of DC cells connected in series to form a cell unit providing a DC power source approximately equal to a working voltage. A frequency conversion/voltage stabilizing circuit has an input side electrically connected to the DC power source and an output side electrically connected to a water pump. The frequency conversion/voltage stabilizing circuit is capable of providing conversion between AC and DC and changing output AC power frequency and output voltage. The output side outputs an AC power with an AC working voltage to the water pump. The effect and operational stability of the water pump can be enhanced.

### BACKGROUND OF THE INVENTION

1. Field of the Invention

The present invention relates to an inverter with uninterruptible power supply for a water pump and, more particularly, to an inverter with uninterruptible power supply providing enhanced effect and enhanced operational stability.

2. Description of the Related Art

It is well known to connect an inverter with uninterruptible power supply to a water pump to prevent loss resulting from interruption of supply of water due to electricity outage. FIG. 2 shows a conventional arrangement of an inverter with uninterruptible power supply for a water pump. The inverter is electrically connected to an AC power source and a DC power source 1′ in the form of a cell of DC 24V or DC 12V. The DC power source 1′ is electrically connected to a voltage increasing/decreasing circuit 2′, which, in turn is electrically connected to a conversion/voltage stabilizing circuit 3′ that outputs AC power with a working voltage of AC 120V or AC 240V to the water pump. When the AC power source input to the inverter is normal, the AC power source is directly outputted to the water pump and charges the DC power source 1′ via the voltage increasing/deceasing circuit 2′ and the conversion/voltage stabilizing circuit 3′. When the AC power source input to the inverter is stopped, the inverter increases the voltage of the DC power source 1′ to the working voltage via the voltage increasing/decreasing circuit 2′. Then, the conversion/voltage stabilizing circuit 3′ converts the working voltage into an AC working voltage before output to the water pump. Operation of the water pump is, thus, maintained.

However, the effect is unsatisfactory and energy is lost during the increase of voltage by the voltage increasing/decreasing circuit 2′ or any transformer. Furthermore, the voltage of the AC power source must be decreased before it can be utilized for charging the DC power source 1′. The charging speed is, thus, low. Further, the inverter can not change the output frequency in response to the operation of the water pump. As an example, the frequency can not be changed when water pump requires larger current during starting, such that the operation is unstable and that the inverter is liable to be damaged.

### BRIEF SUMMARY OF THE INVENTION

An objective of the present invention is to provide an inverter with uninterruptible power supply providing enhanced effect and enhanced operational stability.

An inverter with uninterruptible power supply for a water pump according to the preferred teachings of the present invention includes a plurality of DC cells connected in series to form a DC cell unit providing a DC power source approximately equal to a working voltage. The inverter further includes a frequency conversion/voltage stabilizing circuit capable of providing conversion between AC and DC and changing output AC power frequency and output voltage. The frequency conversion/voltage stabilizing circuit has an input side electrically connected to the DC power source and an output side adapted to be electrically connected to a water pump. The output side outputs an AC power with an AC working voltage to the water pump.

In a case that no AC power is input to the inverter due to electricity outage, the DC cells can input power to the frequency conversion/voltage stabilizing circuit and be converted into an AC working voltage to the water pump. Since the DC cells have a voltage approximately equal to the working voltage, increase of voltage is not required, avoiding loss of power of conventional transformers in voltage increasing operation. On the other hand, when the AC power is normal, the alternate current can be converted into a DC power by the frequency conversion/voltage stabilizing circuit to directly charge the DC cells, increasing the charging speed. Furthermore, the output AC power frequency and output voltage of the frequency conversion/voltage stabilizing circuit can be varied in response to the operating conditions of the water pump, providing enhanced stability.

The present invention will become clearer in light of the following detailed description of illustrative embodiments of this invention described in connection with the drawings.

### DESCRIPTION OF THE DRAWINGS

The illustrative embodiments may best be described by reference to the accompanying drawings where:

FIG. 1 shows a diagrammatic view of an inverter with uninterruptible power supply for a water pump according to the preferred teachings of the present invention.

FIG. 2 shows a diagrammatic view of an inverter with uninterruptible power supply for a water pump according to the prior art.

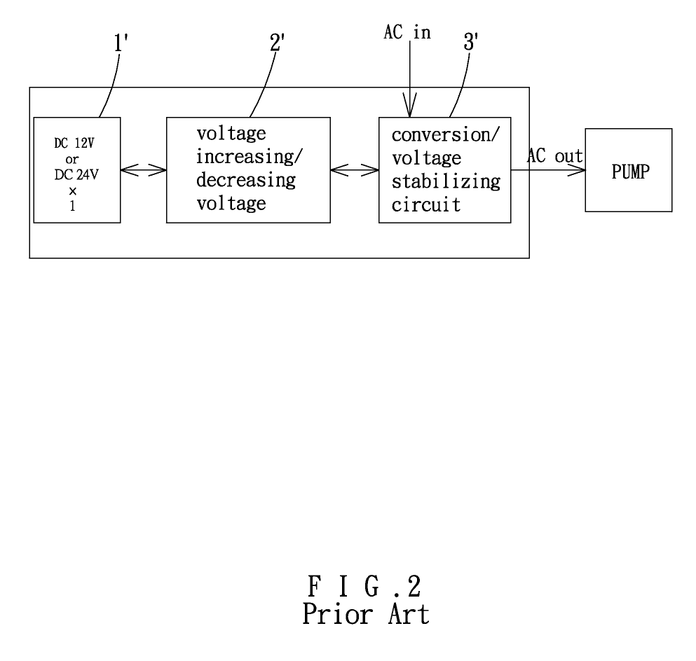

All figures are drawn for ease of explanation of the basic teachings of the present invention only; the extensions of the figures with respect to number, position, relationship, and dimensions of the parts to form the preferred embodiments will be explained or will be within the skill of the art after the following teachings of the present invention have been read and understood. Further, the exact dimensions and dimensional proportions to conform to specific force, weight, strength, and similar requirements will likewise be within the skill of the art after the following teachings of the present invention have been read and understood.

### DETAILED DESCRIPTION OF THE INVENTION

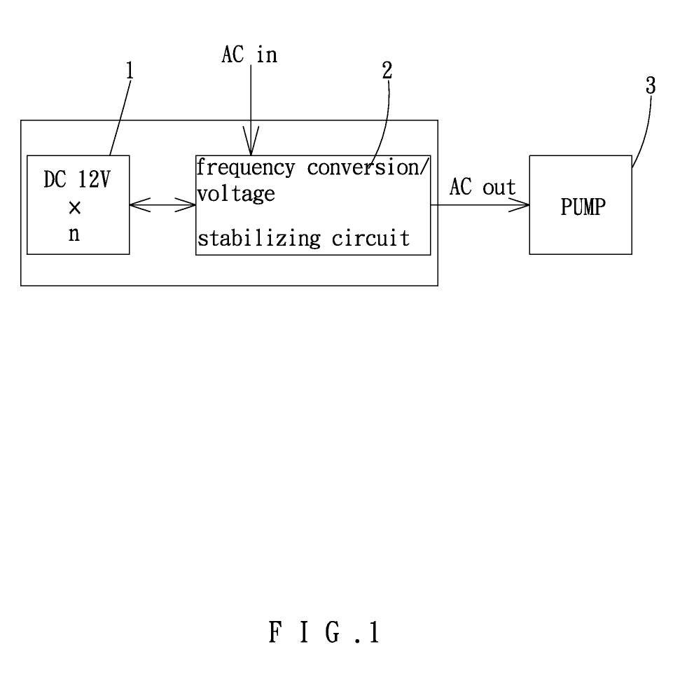

An inverter with uninterruptible power supply for a water pump according to the preferred teachings of the present invention is shown in FIG. 1 and generally includes a plurality of DC cells 1 (see n in FIG. 1) connected in series to form a DC cell unit providing a DC power source approximately equal to a working voltage. In the most preferred form shown, the cell unit includes at least twelve DC cells 1 each of 12V, providing a DC power source approximately equal to a working voltage. The inverter with uninterruptible power supply further includes a frequency conversion/voltage stabilizing circuit 2 capable of providing conversion between AC and DC and changing output AC power frequency and output voltage. The frequency conversion/voltage stabilizing circuit 2 has an input side electrically connected to the DC power source and an output side adapted to be electrically connected to a water pump 3. The water pump 3 can be smaller than 3 KVA. The output side outputs an AC power with an AC working voltage to the water pump 3.

In a case that no AC power is input to the inverter due to electricity outage, the DC cells 1 can input power to the frequency conversion/voltage stabilizing circuit 2 and be converted into an AC working voltage of about AC 120V to the water pump 3. Since the DC cells 1 have a voltage approximately equal to the working voltage, increase of voltage is not required, avoiding loss of power of conventional transformers in voltage increasing operation. On the other hand, when the AC power is normal, the alternate current can be converted into a DC power by the frequency conversion/voltage stabilizing circuit 2 to directly charge the DC cells 1, increasing the charging speed.

The output AC power frequency and output voltage of the frequency conversion/voltage stabilizing circuit 2 can be varied in response to the operating conditions of the water pump 3, providing enhanced stability. Thus, the frequency and voltage can be changed during starting of the water pump 3 to avoid damage to the inverter and the water pump 3.

The number of the DC cells 1 according to the teachings of the present invention can be varied according to the working voltage. As an example, in a case that the working voltage is 240V, the number of the serially connected DC cells 1 can be increased to be approximately equal to the working voltage.

Thus since the invention disclosed herein may be embodied in other specific forms without departing from the spirit or general characteristics thereof, some of which forms have been indicated, the embodiments described herein are to be considered in all respects illustrative and not restrictive. The scope of the invention is to be indicated by the appended claims, rather than by the foregoing description, and all changes which come within the meaning and range of equivalency of the claims are intended to be embraced therein.

1. An inverter with uninterruptible power supply for a water pump, comprising:
a plurality of DC cells connected in series to form a DC cell unit providing a DC power source approximately equal to a working voltage;
a frequency conversion/voltage stabilizing circuit capable of providing conversion between AC and DC and changing output AC power frequency and output voltage, with the frequency conversion/voltage stabilizing circuit having an input side electrically connected to the DC power source and an output side adapted to be electrically connected to a water pump, with the output side outputting an AC power with an AC working voltage to the water pump.

2. The inverter with uninterruptible power supply as claimed in claim 1, with the cell unit including at least twelve cells of DC 12V connected in series.
